(19) United States
(12) Patent Application Publication
(10) Pub. No.: US 2013/0234844 A1
(43) Pub. Date: Sep. 12, 2013

(54) DOOR OPENING WARNING BASED ON APPROACHING OBJECTS

(71) Applicant: Wilford Trent Yopp, Canton, MI (US)

(72) Inventor: Wilford Trent Yopp, Canton, MI (US)

(73) Assignee: FORD GLOBAL TECHNOLOGIES, LLC, Dearborn, MI (US)

(21) Appl. No.: 13/417,373

(22) Filed: Mar. 12, 2012

(51) Int. Cl. B60Q 1/00

(52) U.S. Cl. 340/435

(57) ABSTRACT

A method and a system for warning a door user of a vehicle about any unsafe door opening conditions, continuously monitors the vehicle's surroundings. The system defines a door clearance zone by identifying the total area traveled over by the door when it is completely swung to open. The system augments the door clearance to define an entrance/exit clearance zone. Further, the system continuously detects any vehicles or objects either currently lying within, or potentially likely to be in the door clearance zone or the entrance/exit clearance zone. For any objects or vehicles identified being currently or potentially likely to be in any of the two clearance zones, the system provides a visual or an auditory warning signal to the user, indicating that it is unsafe to open the vehicle's door.

### TECHNICAL FIELD

The present disclosure generally relates to vehicle protection systems, and more specifically to systems for providing safe door-opening signals based on approaching objects or vehicles.

### BACKGROUND

Currently, many vehicles are equipped with safety systems, including collision threat detection systems, systems for identifying and continuously monitoring vehicles, pedestrians and other objects/obstacles in the near vicinity of an occupant's vehicle and those in the vehicle's blind-spot region, and lane change assist systems (LCA) for assisting an occupant when he desires to change lanes while driving. Some of these systems are based on radar-based sensors and/or vision-based sensors which are positioned at appropriate locations on the vehicle. Some vehicles are also equipped with high precision side-sensing systems known in the art, including the blind-spot monitoring system that uses short range radar sensing technique, operating at about 24 GHz in normal mode of operation. Other known examples of predominantly used side-sensing systems include the Eaton VORAD system that uses range-gated Doppler radar that operates at about 24 GHz, and the Valeo Raytheon system that uses similar frequency multi-beam radars for blind-spot monitoring on both the sides of the vehicle. Those skilled in the art are aware that other types of sensors can be used to accomplish the above functions and also provide additional safety features.

If a user desires to open a vehicle's door, to enter or exit the vehicle, an accurate estimation of approaching objects/vehicles in the vicinity of the user's vehicle (hereinafter referred to as “host vehicle”) is extremely crucial. This information is needed for not only safe door-opening, but also for the safety of people entering or exiting the vehicle, to avoid any potential impact from an approaching object, vehicle or something else. Door clearance is an extremely important parameter for enabling hassle-free entry into, or exit from a vehicle. The door-clearance parameter varies based on the vehicle's dimensions, the occupant's age and physical build, and other conditions surrounding the vehicle. Specifically, the door clearance required for an adult is generally more than that required for a child. Further, vehicles equipped with single side-door openings generally require a larger door clearance than those equipped with separate front and rear side-doors. Also, in adverse weather conditions, such as rain, snow or foggy conditions, the estimation of when a door can be safely opened can become extremely difficult.

Generally, information regarding any detected approaching vehicle or an obstacle around the host vehicle, as identified by the host vehicle's side-sensing system, is displayed on a small display screen provided within the host vehicle's interiors. Considering the small size of such screens, the occupant does not accurately construe the exact distance of the vehicle/object in the host vehicle's vicinity. Many times, the corresponding images rendered on the display screen are not true to scale, though they roughly provide information pertaining to the objects and vehicles around the host vehicle. Due to this, the occupant is unable to confidently predict whether it is safe to open the door.

Therefore, there exists a need for a system and a method to more accurately warn people entering or exiting a vehicle when any unsafe conditions exist.

### SUMMARY

The present disclosure provides a method and a system for providing assistance to people desiring to enter or exit a vehicle, and provides warning signals to the people, if an unsafe condition exists, prior to, or during opening of any of the vehicle's doors.

In one aspect, this disclosure provides a method for warning a user of a vehicle's door, if an unsafe condition exists while the user desires to open the door, to enter/exit the vehicle. The method defines a door-clearance zone by determining the total space traveled over by the door, as the door is completely swung to open. Further, the method defines an entrance/exit clearance zone by augmenting an additional space to the door clearance zone, based on certain conditions. Then, the method identifies any objects or vehicles potentially likely to be in any of the two zones. For such identified objects or vehicles, the method calculates an approximate time after which such objects or vehicles are expected to enter the respective zone. Thereafter, the method provides a visual or a verbal alarming signal to the door user, after a specific time, based on certain conditions.

In another aspect, the present disclosure provides a system for warning a user of a vehicle's door, if an unsafe condition exists, when the user desires to open the door. The system includes a detection module that identifies any objects, pedestrians or vehicles that are potentially likely to be in a pre-defined door clearance zone or an entrance/exit clearance zone corresponding to the door. A controller is connected to the detection module and it stores information pertaining to the entering/exiting clearance zone and the door clearance zone. The detection module includes multiple sensors for continuously monitoring the vehicle's surroundings, and to identify potentially threatening conditions. The communication module delivers warning signals to the door user, corresponding to such conditions. Specifically, through its sensors, the detection module identifies all objects, pedestrians or vehicles that are potentially likely to be in the entering/existing clearance zone while a person is entering or existing, or loading the vehicle.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 is a flow chart showing the different steps involved in the method for providing assistance to people desiring to enter or exist a vehicle through any of its doors, and warning them of detected unsafe conditions, in accordance with the present disclosure.

FIG. 2 illustrates a system in according with the present disclosure, for assisting people desiring to enter or exit a vehicle, and warning them of any detected unsafe conditions.

FIG. 3 shows a top-view of the host vehicle, depicting a door opening clearance zone for one of the vehicle's doors, and the associated entrance/exist clearance zone for that door.

FIG. 4 shows an interface that displays a visual warning signal to a door user, during unsafe door opening conditions.

### DETAILED DESCRIPTION OF ILLUSTRATIVE EMBODIMENTS

The following detailed description elucidates aspects of the disclosure and the ways it can be implemented. However, the description does not define or limit the invention, such definition or limitation being solely contained in the claims appended thereto. Although the best mode of carrying out the invention has been disclosed, those skilled in the art would recognize that other embodiments for carrying out or practicing the invention are also possible.

The present disclosure pertains to a system and a method for providing assistance to people, during the moments when they desire to enter or exit the vehicle. Further, the disclosure provides a method and a system for warning the people about any unsafe conditions that are detected, when the vehicle's door is opened, or is desired to be opened.

Currently, many advanced systems are available in the art for accurately monitoring a vehicle's surroundings and identifying/detecting any vehicles or objects lying in the vicinity of the vehicle. Many of these systems are used for providing assistance to drivers during moments when they wish to change lanes while driving. Such systems are also used for providing collision threats to the occupant, if any vehicle is found to steadily approach the host vehicle, or is continuously identified being present within a specific distance in the near vicinity of the host vehicle. Information gathered by such systems is generally displayed on small display screens, or heads up displays provided within the vehicle's interiors. Further, due to space constraints, such screens or interfaces are often small in size, and the displayed information images are often not to scale, and hence, not sufficient for the occupant to interpret the exact distance of any vehicles currently or potentially likely to be in the vicinity of the host vehicle. Therefore, the vehicle occupants may not be able to correctly judge when it is safe to open the door.

The present disclosure unveils a more accurate method and a system for providing assistance to people when they desire to open a vehicle's door, and provides warning signals to the people, regarding any approaching objects, pedestrians or vehicles that pose a threat of being in the clearance zone at approximately the same time that they wish to open the vehicle's door. The warning signals can be auditory, and/or can be conveyed through a visual warning.

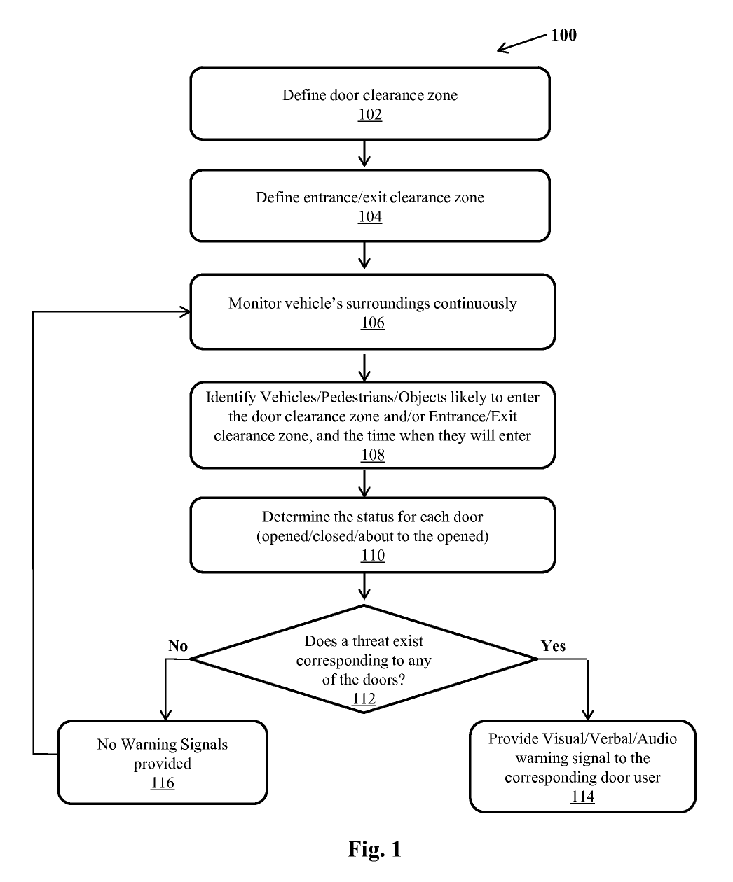

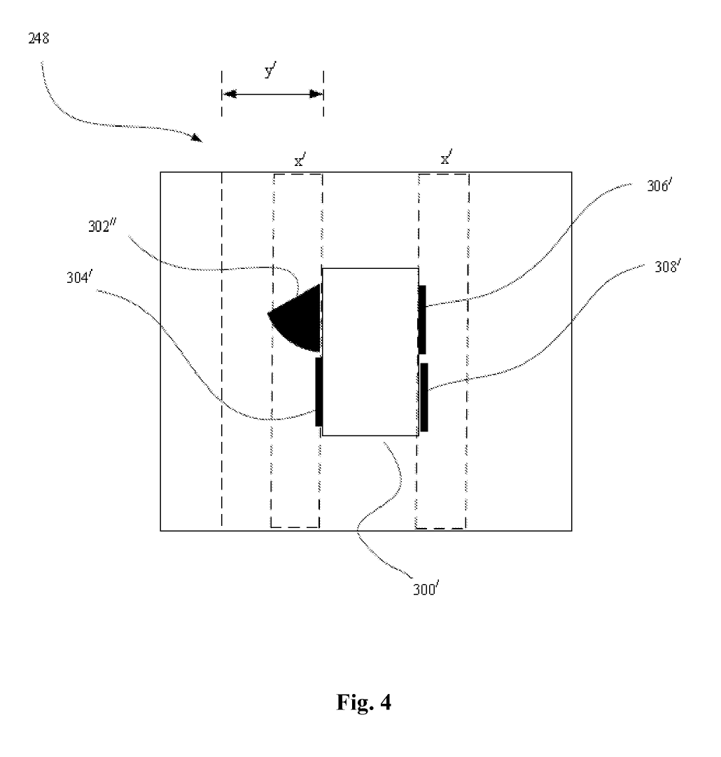

FIG. 1 is a flowchart showing the different steps involved in an exemplary method 100 in accordance with the present disclosure, for providing assistance to the users of a vehicle, when they desire to open any of the vehicle's doors. Hereinafter, the vehicle, any of whose doors is desired to be opened, will be simply referred to as ‘host vehicle’. At step 102, the method 100 defines a door clearance zone for the host vehicle. At this step, the method 100 identifies the total space traveled over by the door when it is completely swung from the closed position to the open position. The user of the host vehicle may also incorporate some additional clearance space to extend the dimensions of the door clearance zone, for more safety, during defining it. This space is construed as the door-clearance zone. The door clearance zone parameter may vary, based on different conditions. Such conditions include, but not limited to, the size and the type of vehicle, and also the specifications of the vehicle's door. For example, a vehicle with a single door opening on both the sides will generally have a larger door clearance space than a vehicle equipped with double door opening on both sides. Further, bigger vehicles, including the SUVs and land rovers, will have a larger door clearance space than comparatively smaller cars. The door clearance zone is depicted clearly in FIG. 4, which will be explained in details later. At step 104, the method 100 defines an entrance/exit clearance zone for the host vehicle. At this step, the method 100 identifies a clearance space required for a person to safely enter or exit the vehicle, in circumstances when any other moving vehicles, pedestrians or objects are in the vicinity of the host vehicle. Further, during defining the entrance/exit clearance zone, the method 100, in an embodiment, may use the pre-defined door clearance zone and incorporate some additional space to it, based on a fair approximation, to incorporate such circumstances. This space is construed as the entrance or exit clearance zone. The entrance/exit clearance zone parameter may vary, based on different conditions. Such conditions include, but not limited to, the speed and number of the detected vehicles, pedestrian and objects that are determined to pose a risk to the door user. At step 106, the method 100 continuously monitors the host vehicle's surroundings and collects the host vehicle's environment data. This step includes identifying and detecting any vehicles, pedestrians or objects lying in the vicinity of the host vehicle. Many known systems available in the art can be used for this purpose. Specifically, the host vehicle can be equipped with a number of radar-based and vision-based sensors to continuously monitor its surroundings. Further, high-precision systems for driver's safety, including a lane change assist (LCA) system, a Valeo Raytheon system, or an Eaton VORAD system, can also be used to accurately identify vehicles approaching the host vehicles. These systems typically use forward and side radar sensors positioned on the vehicle, to detect the presence and movement of vehicles around the host vehicle, and to alert the occupant of the host vehicle.

At step 108, the method 100 identifies any vehicles, pedestrians and objects that are expected to enter the door clearance zone and/or the entrance/exit clearance zone and evaluates the time when they will enter, and eventually leave the zone. For this, the method specifically identifies vehicles near the host vehicle, and projects their current trajectories forward. If the projected trajectory of any such identified vehicle intersects the door clearance zone or the entrance/exit clearance zone, then the identified vehicle is construed to eventually enter the door clearance zone or the entrance/exit clearance zone, respectively. Further, in an embodiment, through the different external sensors positioned on or within the host vehicle, the method 100 checks whether any of the vehicles approaching the host vehicle has a component of its velocity or acceleration towards the host vehicle. If yes, then such an approaching vehicle may be potentially likely to enter any of the two clearance zones. Further, for determining the time after which an identified vehicle, object or pedestrian is expected to be in the door clearance zone or the entrance/exit clearance zone, the method determines the relative speed of approach and/or the acceleration of approach of such a vehicle or object, and by knowing the initial distance of the approaching vehicle, object or pedestrian from the host vehicle, the method 100 calculates the time.

At step 110, the method 100 determines the current status of each of the host vehicle's doors. Specifically, the method 100, at step 110, checks for each specific door, whether the door is either opened, or closed, or is about to be opened. At step 112, the method 100 uses the information gained at steps 108 and 110, and evaluates whether any of the host vehicle's doors is a subject to a threat. If yes, then at step 114, the method 100 provides appropriate warning signals to the corresponding door user. Else, if no such threat exists, then at step 116, no warning signals are provided, and the method 100 routes back to step 106, and continues monitoring the vehicle's surroundings. Specifically, at step 114, the method 100 may provide a visual or an auditory alarm signal to the occupant, after a specific time, when any such object or vehicle is expected to enter the host vehicle's clearance zone. Specifically, the time after which such a signal is delivered depends upon the calculated time after which the vehicle or object or pedestrian is expected to enter the door clearance zone or the entrance/exit clearance zone. In one aspect, such an alarming signal is provided about 10-15 seconds prior to the calculated time. However, the specific time can also be pre-defined by the occupant, based on the level of security desired. Typical voice communication systems known in the art are used for warning the door user through an audio communication message. In other less preferred embodiments, a warning sound can be generated. In case if the occupant is warned through a visual signal, such a signal is rendered on one or more interfaces or heads-up-displays provided within the host vehicle. Such interfaces or heads-up displays can be positioned at appropriate locations near each of the host vehicle's doors or any other suitable location, and appropriately positioned within the field of vision of the corresponding door users. The signal can be conveyed through a colorized beep, like a red blinking signal, for example. Such a beep continuously blinks when the approaching vehicle or object entered the door clearance zone or the entrance/exit clearance zone. In an embodiment, the warning signal can also beep louder or blink faster, as the approaching vehicle/object gets closer to a door, to enable the user have information about the increase in the severity of the threat, as the approaching vehicle/objects gets closer. In one aspect, both an audio and a visual signal are provided, to incorporate the cases when the occupant may not be attentive enough. This includes a colorized beep accompanied by an audible sound, or a verbal description of the threat, for example, ‘Don't open the door, threat identified, vehicle approaching’ etc.

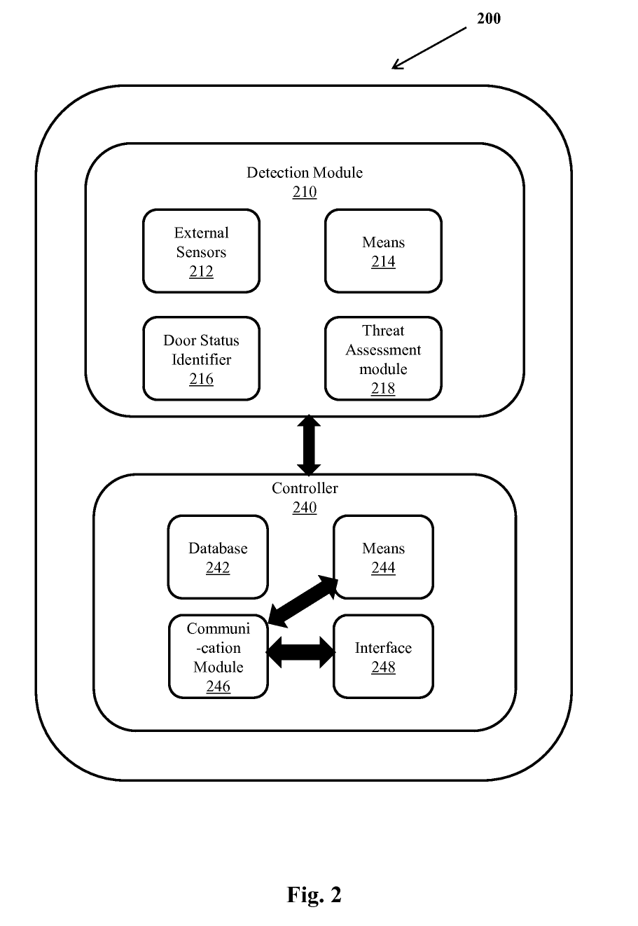

FIG. 2 shows an exemplary system for assisting users of the host vehicle, and for communicating warning signals to the users, if an unsafe condition exists when they desire to open one or more of the vehicle's doors, in accordance with the present disclosure. As shown, the system 200 includes a detection module 210 (referred to as ‘module 210’ hereinafter) and a controller 240 connected to it. The detection module includes a means 214 that defines the door clearance zone by determining the total space traveled over by the door when it is completely swung to open. Further, the means 214 defines the entrance/exit clearance zone by incorporating some additional space that may be needed by people entering, exiting or loading the vehicle, to the door clearance zone. The detection module 210 also includes external sensors 212 for continuously monitoring the host vehicle's surroundings. Specifically, the external sensors 212 detect any vehicles, pedestrians or objects lying in proximity to the host vehicle. Further, these external sensors 212 identify any objects, pedestrians or vehicles that are potentially likely to be in the entrance/exit clearance zone when a door is desired to be opened. To accomplish this, the external sensors identify vehicles, pedestrians and objects whose predicted paths intersect the defined entrance/exit clearance zone. Those skilled in the art will recognize that there are several ways to accomplish this based on information gained from the external sensors 212, like the velocity, acceleration or direction of approach of detected vehicles/object, relative to the host vehicle. The module 210 further includes a number of door status detectors 216 which indicate whether a door is either opened, closed or is about to be opened. A threat assessment module 218 continuously identifies when such detected vehicles/objects are likely to be within the entrance/exit clearance zone.

In an embodiment, the module 210 uses a highly accurate and precise driver safety system for monitoring the vehicle's surrounding (not shown). As described before, such a system can be a side-sensing system known in the art for blind-spot monitoring, which uses short range radar sensing techniques and operates at about 24 GHz in the normal mode of operation. Further, the module 210 can use range-gated Doppler radar operating at about 24 GHz to identify the vehicles and objects in the vicinity of the host vehicle. Further, in another embodiment, the module 210 uses multi-beam radar of similar frequency for blind-spot monitoring on both side of the vehicle. Those skilled in the art are aware that other types of sensors can be used to accomplish the above functions and also provide additional safety features.

The controller 240 is coupled to the module 210 and obtains information from it. The controller 240 includes a database 242 which stores information pertaining to the entrance/exit clearance zone of the host vehicle, as determined by the means 214 of the module 210. Specifically, the database 242 keeps data corresponding to the dimensions of the entrance/exit clearance zone for each of the host vehicle's doors, and its extent of spread, away from the corresponding doors. In an embodiment, certain pre-determined images of the entrance/exit clearance zone are stored in the database 242. If the module 210 identifies that any vehicles, pedestrians or objects are expected to be within the entrance/exit clearance zone of any of the host vehicle's doors, it conveys signals to the controller 240. On receiving such signals, the controller 240 activates a communication module 246. The communication module 246 immediately conveys warning signals to the user of the corresponding door, who desires to open the door. Such a warning signal is either a visual signal rendered on an interface 248, or an audio signal (i.e., a verbal alert), or a combination thereof. As described earlier, the communication module 246 conveys a visual signal, for example, a red beep, indicating the presence of an unsafe door opening condition. Not limiting the scope of the disclosure, any other form a visual communication message can be rendered by the communication module 246 on the interface 248. Further, in an embodiment, the communication module 246 is configured to render warning signals more frequently, to let a door user have an idea of the increase in the severity of the threat, as an approaching vehicle/object gets closer. For example, if a blinking beep is used to warn a specific door user, then the beep may blink more frequently and the accompanying audio alert may get louder, as the approaching vehicle/object gets closer. The interface 248 is provided at an appropriate location, such that the rendered visual signal is easily visible to the vehicle occupants, and to those desiring to enter the vehicle. In an embodiment, separate interfaces 248 are provided and positioned at appropriate locations proximal to each of the host vehicle's doors, to enable visibility of the rendered visual warning signal to the corresponding door users. The interface 248 can be a separate display screen, or it can also be incorporated within the heads-up-display, overlaying the forward vision of the driver of the host vehicle. Any appropriate screen-based display, including an LCD, an LED or a CRT display, can be used as the interface 248, for accomplishing the purpose of rendering a visual warning signal to the occupant. Not limiting the scope of the disclosure, any other display device known in the art can also be contemplated. In an embodiment, the interface 248 clearly renders an image of the host vehicle to the occupant, depicting the entrance/exit clearance zone and also showing the vehicle or object currently present within the clearance zone. This will be explained in details hereinafter, in conjunction with FIG. 4.

The communication module can also provide an auditory warning alert to those desiring to open a host vehicle door. Those skilled in the art will recognize that typical voice communication systems available conventionally, can be used for this purpose. An appropriate distinguishable verbal message is communicated in such a case, clearly informing about an unsafe door opening condition. Further, in an embodiment, the communication module 246 conveys both a verbal and a visual signal to those desiring to open any of the host vehicle's doors, if a threat is identified corresponding to that door. For example, such a message is a blinking colorized beep accompanied by an audible sound synchronizing with the beep. The conveyed warning signal is continuously delivered till the identified object, pedestrian or vehicle is no longer perceived as a threat by module 218. Further, in one aspect of the disclosure, the communication module 246 conveys distinguishably different verbal messages corresponding to identified threats pertaining to different host vehicle doors. Descriptively, for example, a verbal message corresponding to an object, pedestrian or a vehicle identified lying within the front left door's entrance/exit clearance zone, may be distinguishably different from the communication message corresponding to the rear right side door, thus clearly indicating which door is specifically unsafe to open. For this purpose, different tones may be employed for distinguishing audio-alerts corresponding to different doors. The corresponding verbal messages can also be differentiated by pre-setting different pitch or frequency values, or pre-defining the content of the audio alert signals corresponding to different doors. Those skilled in the art are aware that there are other ways to intimate a user of a specific door to which the threat is posed, such as, localizing the audio alert in proximity to that door, to accomplish this purpose.

Certain aspects of the present disclosure may solely rely on communicating an auditory warning message to the occupant, and in those embodiments, no such interface 248, as described, is incorporated. The system will merely trigger the communication module 246 to deliver an audio alert to those desiring to open a specific door, if any object, pedestrian or vehicle is identified to potentially occupy the entrance/exit clearance zone of that door.

For the objects, pedestrians or vehicles detected by the external sensors 212, a means 244 calculates when such vehicles, pedestrians or objects are expected to occupy any portion of the entrance/exit clearance zone. Specifically, the means 244 continuously obtains information from the external sensors 212, regarding the relative velocity of approach, the relative acceleration of approach and the predicted path of such vehicles, pedestrians and objects. With this data, the means 244 calculates an approximate time that such vehicles, pedestrians or objects will occupy the clearance zone. As shown, being coupled to the communication module 246, the means 244 provides this calculated time to the communication module 246. The communication module 246 provides a visual or a verbal warning signal, based on the time calculated by means 244, and correlating it with the time when a specific door is being used. For example, a warning signal corresponding to vehicles about to enter the entrance/exit clearance zone of a specific door, is delivered a few seconds before the calculated time when the identified vehicle, object or pedestrian will enter the entrance/exit clearance zone of that door. This lead time can be customized based on the level of security desired and on user's preferences.

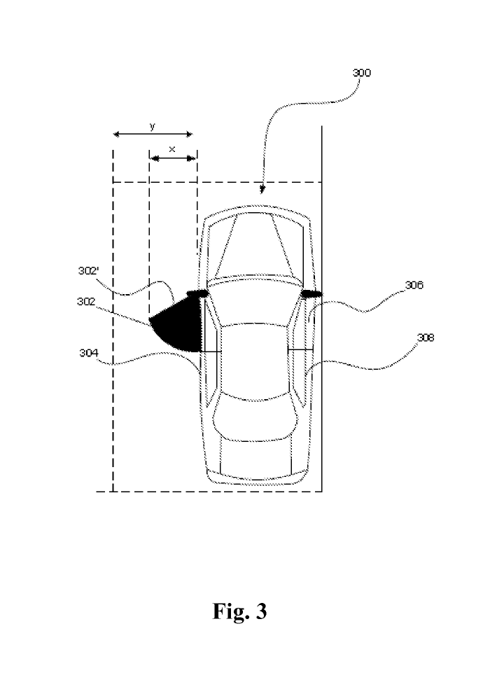

FIG. 3 shows the top view of the host vehicle 300, clearly illustrating the door clearance zone and the entrance/exit clearance zone for one of the vehicle's doors. As shown, the host vehicle 300 has two front doors 302 and 306, and two rear doors 304 and 308. The shaded black area, i.e., area 302′ represents the door clearance zone corresponding to the front left door 302. Specifically, the shaded area 302′ is the area swept by the front left door 302, as it is swung completely to open. Similarly, the other doors have their own respective clearance zones (though not shown). As shown, the door clearance zone extends to a specific distance ‘x’ from the extreme left side edge of the host vehicle 300. Specifically, the width ‘x’, as shown, corresponds to the space swapped by the front left door 302, when it is completely swung to open. Further, the \width ‘y’ corresponds to the entrance/exit clearance zone for the door 302. As shown, the door clearance zone 302′ is extended, and an additional clearance space is incorporated to it, to define the entrance/exit clearance zone. This additional space takes into account, the additional space required for a user entering/exiting the vehicle, when any approaching vehicles, pedestrians or objects are identified in the vicinity. The approaching vehicles possess a specific speed and there may be some uncertainty about their predicted future path. Hence, for providing more safety to the user of the door, and for incorporating the variation in a door user's physical built/needs, this additional clearance space is added to the door clearance zone 302′, to define the entrance/exit clearance zone for the host vehicle 300. Specifically, if any approaching vehicle is identified to be within the distance range ‘y’ from the host vehicle, the host vehicle's door user is provided with an alert signal. Further, if any approaching vehicle is identified to be within the distance range ‘x’ from the host vehicle, i.e., within the door clearance zone 302′, the door user is provided with a different alert signal to warn the user of an even greater risk. The extent and dimensions of the two clearance zones, corresponding to the different doors of the host vehicle 300, is stored accurately in the vehicle's controller 240 illustrated in FIG. 2 earlier.

FIG. 4 shows the interface 248 of the controller 240 of FIG. 2, for displaying visual warning signals to the host vehicle's door users during unsafe door opening conditions. As aforementioned, the interface 248 is positioned at an appropriate location within the vision field of the host vehicle's driver and/or door users. As shown, an image 300′ of the host vehicle is formed on the interface 248. The rendered image 300′ is scaled down, but the proportionate dimensions can remain the same as the actual dimensions of the host vehicle. Further, as shown, the image 306′ corresponds to the front side door 306, and the images 304′ and 308′ correspond to the rear side doors 304 and 308 respectively, shown in FIG. 3 earlier. The image 302″ shows the door clearance zone corresponding to the front left door 302. As shown, in the displayed image, the interface 248 clearly shows the scaled-down width ‘x′’ of the displayed door clearance zone 302″. A similar clearance zone width ‘x′’ is shown corresponding to the front right side door. Further, the distance ‘y′’ corresponds to the entrance/exit clearance zone for approaching objects, pedestrians and vehicles. Though the figure shows only one door clearance zone, in an embodiment, the interface 248 is configured to continuously display the door clearance zone corresponding to the other doors of the host vehicle. In an embodiment, while providing the visual warning signal to a user of any of the host vehicle's doors, an image of an identified vehicle or object, that will potentially occupying the entrance/exit clearance zone or the door clearance zone of that door, is also displayed clearly (though not shown). Further, in an embodiment, for such an approaching vehicle, pedestrian or an object, its exact distance from the door clearance zone and it's expected time of arrival, is also continuously displayed on the interface 248. This enables the door user to have a continuous perception of the proximity of such an object, pedestrian or vehicle, and allows him to judge when it is safe to open the door. Not limiting the scope of the disclosure, the displayed image can be rendered in a relatively more schematic form, or in comparatively more graphical details too. The exact specifications of the content and the visual appeal of the rendered image can be customized and pre-defined, based on the user's desire, and such specifications depend primarily on the budget constraints and the desired aesthetic appeal.

Augmenting the entrance/exit clearance zone for any or all of the vehicle's doors, pre-defining their widths, and taking into account the expected time for which the user's door well be kept opened, based on the user's desire and comfort, lies within the scope of the present disclosure. Specifically, certain users may take more time to enter or exit the vehicle, based on their physical built and age, as compared to others, and the actual time for which the door is used by a specific user, may depend on certain conditions. Further, based on the physical built of the different users and their abilities, the clearance zones for specific doors can also be extended or shortened. As an example, for more safety, if a large or older person is sitting on the rear left side seat, then the complete space swapped by the rear left side door, when swung to open, can be used as its door clearance zone, and the entrance/exit clearance zone for that door can be obtained by augmenting the door clearance zone with some more additional space, beyond the standard default settings.

The disclosed method and system for assisting those desiring to open a vehicle door(s), about any unsafe door opening conditions, can be used and implemented in vehicles of any type and dimensions, including cars, land rovers, trucks etc.

Although the current invention has been described comprehensively, in considerable details to cover the possible aspects and embodiments, those skilled in the art would recognize that other versions of the invention may also be possible. Further, though the disclosure has been presented with reference to specific embodiments, the description is not intended to limit the scope of the disclosure. It is therefore contemplated that any appropriate modifications can be made, without departing from the scope of the disclosure.

What is claimed is:

1. A method for providing assistance to a door user of a host vehicle, when the user desires to open the door, and warning the user about an unsafe door opening condition, the method comprising:
defining a door-clearance zone by determining the space traveled over by the door when the door is brought from a closed position to an open position;
defining an entrance/exit clearance zone by augmenting the door clearance zone with an additional space, based on a set of conditions;
identifying objects and vehicles potentially likely to be in at least one of the door clearance zone and the entrance/exit clearance zone; and
providing an alarm signal to the user, if any objects or vehicles are identified as potentially likely to be in at least one of the door clearance zone and the entrance/exit clearance zone.

2. A method of claim 1, further comprising, for objects or vehicles potentially likely to be in the door clearance zone and the entrance/exit clearance zone, calculating a time after which such identified objects or vehicles are expected to be in the respective clearance zones, based on certain conditions.

3. A method of claim 1, further comprising projecting forward the current trajectories of the vehicles proximal to the host vehicle, and construing any vehicle as potentially likely to enter at least one of the door-clearance zone and the entrance/exit clearance zone, if its projected territory intersects the corresponding clearance zone.

4. A method of claim 1, further comprising interpreting an approaching vehicle as potentially likely to enter at least one of the door clearance zone and the entrance/exit clearance zone, on identification of a component of the velocity of the approaching vehicle, towards the host vehicle.

5. A method of claim 2, further comprising continuously monitoring the relative speed and the relative acceleration of the vehicles potentially likely to be in the door clearance zone and the entrance/exit clearance zone, with respect to the host vehicle.

6. A method of claim 2, wherein, if any objects or vehicles are identified potentially likely to be in at least one of the door clearance zone and the entrance/exit clearance zone, providing an alarm signal to the user after a specific time, based on the calculated time.

7. A method of claim 1, wherein identifying the objects or vehicle potentially likely to be in at least one of the door clearance zone and the entrance/exit clearance zone includes continuously monitoring host vehicle's environment using radar-based and vision-based sensors provided at appropriate locations on the vehicle.

8. A method of claim 1, further comprising, for vehicles identified potentially likely to be in the door clearance zone and the entrance/exit clearance zone, identifying their current relative speed, relative acceleration and direction of motion with respect to the host vehicle.

9. A method of claim 1, further comprising, providing the alarm signal as an audio alert, a visual alert or a combination thereof, and increasing at least a characteristic property of the alarm signal in relation with the decrease in the distance of the identified object/vehicle from the door clearance zone or the entrance/exit clearance zone.

10. A method of claim 9, wherein the characteristic property is the frequency of the alarm signal or the loudness and pitch of the alarm signal, if the signal is an audio alert.

11. A system for providing assistance to a door user of a host vehicle, when the user desires to open the door, and warning the occupant about an unsafe door opening condition, the system comprising:
a detection module configured to identify any objects or vehicles potentially likely to be in at least one of a pre-defined door-clearance zone and a pre-defined entrance/exit clearance zone; and
a controller operatively coupled to the detection module and storing information pertaining to the door-clearance zone and the entrance/exit clearance zone, the controller being configured to provide a warning signal to the occupant if any objects or vehicles are identified potentially likely to be in at least one of the door-clearance zone and the entrance/exit clearance zone.

12. A system of claim 11, wherein the controller further includes a means configured to calculate the time after which any objects or vehicles identified to be potentially likely within the door-clearance zone and the entrance/exit clearance zone, are expected to enter the respective zone.

13. A system of claim 11, wherein the detection module includes external sensors positioned at appropriate locations on or within the vehicle, for continuously monitoring the vehicle's surroundings.

14. A system of claim 11, wherein the detection module further includes a threat assessment module configured to determine when an identified vehicle or object is expected to be in at least one of the door clearance zone and the entrance/exit clearance zone.

15. A system of claim 11, wherein the controller includes a communication module adapted to provide an auditory or a visual alarm signal to the door user, corresponding to any unsafe door-opening conditions.

16. A system of claim 15, wherein the communication module is configured to increase the loudness of the alarming signal, if the alarming signal is an auditory alarm signal, in relation to the decrease in the distance of the identified object/vehicle from the door clearance zone or the entrance/exit clearance zone.

17. A system of claim 15, wherein the controller includes an interface coupled to the communication module and positioned within the user's forward field of vision, and configured to display the visual alarming signal corresponding to unsafe door-opening conditions.

18. A system of claim 17, wherein the interface is configured to increase the frequency of the displayed visual alarming signal, in relation to the decrease in the distance of the identified object/vehicle from the door clearance zone or the entrance/exit clearance zone.

19. A system of claim 11, further comprising a means configured to define the door-clearance zone by monitoring the total area traveled over by the door when the door is completely swung open.

20. A system of claim 11, wherein the detection module is configured to construe an approaching vehicle as potentially likely to enter at least one of the door clearance zone or the entrance/exit clearance zone, by identifying a component of the velocity of the approaching vehicle, towards the host vehicle.
